(19) United States
(12) Patent Application Publication
(10) Pub. No.: US 2003/0191723 A1
(43) Pub. Date: Oct. 9, 2003

(54) System and method for valuing real property

(76) Inventors: James Christopher Foretich, Alpharetta, GA (US); Mani Young, Cumming, GA (US); William Glen Smith, Canton, GA (US); Elizabeth Arnold Eisworth, Alpharetta, GA (US)

Correspondence Address: Charles B. Lobsenz, Roberts, Mlotkowski & Hobbes, Suite 43-B, 3911 Old Lee Highway, Fairfax, VA, 22030, US

(21) Appl. No.: 10/107,267

(22) Filed: Mar. 28, 2002

(51) Int. Cl. G06F 17/60; G06G 7/00; G06F 17/00

(52) U.S. Cl. 705/400

(57) ABSTRACT

A system is provided such that automated real property valuation may be achieved accurately, rapidly, objectively and consistently. The application accepts information associated with a subject property, such as the street address, and then locates that property in an associated database. Following that, the application computes a valuation for the subject property based upon comparable properties, prior sales history and other factors and data inputs. The system of the present invention accesses databases as necessary for comparable data and automatically and systematically determines the most appropriate comparables to use in arriving at a valuation. Additionally, the system may be customized by various users such that the valuation process may be undertaken in connection with pre-determined criteria such as the number of comparables to use, the maximum acceptable adjustment and other user defined criteria.

### FIELD OF THE INVENTION

The present invention relates generally to systems and methodologies for processing data associated with real estate related transactions and more particularly to a system and method for determining the value of real estate.

### BACKGROUND OF THE INVENTION

The real estate industry represents one of the most broad reaching and diverse industries in existence. Millions of people are involved in businesses that relate in some way to the purchase, sale and/or financing of real properties and countless numbers of transactions occur all over the world every day. Each of these transactions typically involves a large amount of data which needs to be collected, processed, reviewed, verified and used in connection with the effectuation and closing of the particular transaction.

As is the case with many other industries that involve vast amounts of data and the processing thereof, computer systems and software have been deployed to a large degree within the real estate industry. Innumerable software applications and systems have been made available for use by individuals and companies which are involved in all facets of the real estate business and businesses which support real estate related transactions.

Although it is true that the transformation towards the use of information technology, communications and collaborative applications have come more slowly to the real estate and mortgage lending industries than to some other industries, the use of these modern day tools are becoming an increasingly important factor in today's home buying, financing and refinancing markets.

Information technology and collaboration and communication tools bring numerous advantages to the processing of real estate transactions. Among the most important of these advantages are the reduction in transaction processing times and much higher data accuracy. Parties to real estate transactions are far less willing to wait days or even weeks for decisions from lenders. And because of the increasing availability of relevant technology and its facilitation of vast reductions in processing times, lenders and other parties involved in loan transactions are under increasing pressure to reduce the time that it takes them to make home equity and other loan decisions.

One of the steps in the loan process that has traditionally taken the longest time to accomplish and thus tends to be the bottleneck in the process, particularly in the home equity loan process, is the step of valuing the subject property in connection with the loan decision. Since the loan-to-value ratio is of great significance to lenders in making loan decisions as well as in determining applicable loan programs and interest rates, it is almost always necessary for a property valuation to be undertaken in connection with the lending process. In the case of home equity loans, where the rest of the process is relatively simple and straightforward, the time which is required for a valuation to be performed and reported is often the primary cause of delays associated with home equity loan funding.

While there are a great many tools available to lenders, appraisers and others involved in the lending process and particularly in connection with the step of valuing properties, the great majority of them suffer from various drawbacks. In the great majority of cases, lenders engage individuals which have some level of credentials permitting them to perform an appraisal function in a particular jurisdiction. These appraisers use well known techniques and methodologies for arriving at a valuation for a particular property. In the great majority of cases this process requires an appraiser to engage in a number of time consuming activities. These include physically inspecting the subject property, determining and locating a number of comparable properties and possibly visiting them and photographing them, searching databases to determine which properties should be comparables, locating data associated with these comparables, making value adjustments to these comparables based upon the associated data, calculating the adjusted values of all comparables and arriving at a final valuation for the subject property.

As will be understood by one of skill in the art, many of the aspects of the process described above can cause various problems including the introduction of time delays, data inaccuracies, and inconsistencies in methodologies and calculations used for arriving at the ultimate valuation for the subject property. For example, appraisers tend to rely on both public records data and Multiple Listing Service (MLS) databases for information on comparables and subject properties. Unfortunately, public record data is often incomplete or outdated. This may result in comparables which are not the best comparables being selected which, in turn, may lead to a less than ideal valuation. Alternatively, or in addition, the data in public record databases may be inaccurate so as to result, again, in less than ideal valuation results.

Aside from the data source issues discussed above, other problems arise in connection with valuations which are performed manually by human appraisers. One problem is the human error which can occur when any individual must obtain, process, and report large amounts of data. Another problem results from the fact that various lenders and quasi-governmental agencies such as Freddie Mac and Fannie Mae have lending guidelines which differ based upon the loan program, the parties involved and other factors. In addition, these guidelines change frequently over time. Often, these guidelines specify particular criteria and methodologies which are to be employed in the valuation process. One example of this is guidelines which specify when particular comparables may be used in the valuation process and when they may not. Unfortunately, in many cases appraisers do not receive notice of these criteria in connection with valuation assignments or, for some other reason, they do not follow the criteria in performing the valuation.

Yet another problem with the manual valuation process is the ever-present pressure on appraisers to reach pre-defined valuations. If appraisals come in lower than what is necessary for the lender to make the loan, the lender can lose the business and the potential borrower can become agitated. Thus, a level of subjectivity is introduced into the appraisal process which can, in some cases, result in valuations that are not truly reflective of what they should be.

While various software applications have been introduced in recent years to aid appraisers in performing the valuation including applications which prepare valuation reports based upon input provided by the appraiser, these applications suffer from a number of drawbacks. For example, many of these applications do not factor in the lender or agency guidelines discussed above in calculating the valuation for the subject properties. Additionally, many of the existing applications rely on the aforementioned and often less than reliable public records data. Overall, these applications tend to suffer from reliance on less than ideal data on the one hand and a lack of ability to adapt or be customized for different valuation assignments on the other hand.

### SUMMARY OF THE INVENTION

Accordingly, there is a need for a system and methodology which may be implemented as a software application and which addresses the inherent drawbacks associated with prior art valuation processes whether such processes are implemented through prior art software applications or whether performed manually by a human appraiser.

In one embodiment of the present invention, a system is provided such that automated property valuation may be achieved accurately, rapidly, objectively and consistently. The application accepts information associated with a subject property, such as the street address, and then locates that property in an associated database. Following that, the application computes a valuation for the subject property based upon comparable properties, prior sales history and other factors and data inputs.

In another embodiment of the present invention, the system of the present invention accesses a database of “Multiple Listing Service” or MLS data in order to perform the valuation process and in order to obtain data regarding properties available for sale and recently sold properties, or both. The system of the present invention can also access other databases as described below in connection with the gathering of information necessary or desirable to perform the valuation process.

In still another embodiment of the present invention, the system maintains one or more “knowledge base” databases that are continually updated as the system processes valuations. These knowledge base databases can be used either individually or as a supplement to other databases in performing valuations. As will be discussed in greater detail below, knowledge base databases created and maintained by the system of the present invention may include valuation values and comparable information previously calculated and used by the system of the present invention. Thus, for valuations performed later in time, this additional data may be employed to generate the valuation, to make the valuation more accurate, to make the valuation easier to perform or some or all of the above.

In still yet another embodiment of the present invention, the system may be easily customized with respect to a particular lender's needs and/or criteria such that a practically unlimited number of valuation constraints, guidelines and other criteria may be introduced into the valuation methodology with a minimum of effort and a maximum degree of accuracy.

The system and methodologies of the present invention collectively provide a robust, cost efficient, accurate and adaptable solution for valuing real property and for eliminating the problems associated with prior art valuation processes and software applications. One important aspect of the system of the present invention is that it may make use of many different databases in various combinations in order to obtain source information necessary or desirable in connection with the valuation process. For example, MLS data, which tends to be more complete, more accurate and more up to date may be used in place of or in addition to public record data which is often out of date, incomplete and/or inaccurate. As such, more and better comparable data may be obtained and a better valuation result may be obtained.

### BRIEF DESCRIPTION OF THE DRAWINGS

FIG. 1 is a diagram illustrating the system of the present invention in one preferred computing environment;

FIG. 2 is a flowchart illustrating, at a high level, the overall process employed by the system of the present invention in connection with arriving at a valuation for a specific property;

FIG. 3 is a user input screen detailing an exemplary user interface for receiving information from a user prior to performing a valuation;

FIG. 4 is a process flow diagram illustrating the sub-process for matching input data with potential comparable property records as part of the FIND SUBJECT PROPERTY step of the overall process;

FIG. 5 is a process flow diagram illustrating the sub-steps within the FIND COMPARABLES step of the present invention according to a preferred embodiment thereof,

FIG. 6 is a process flow diagram illustrating the sub-steps within the CALCULATE VALUATION step of the present invention according to a preferred embodiment thereof; and

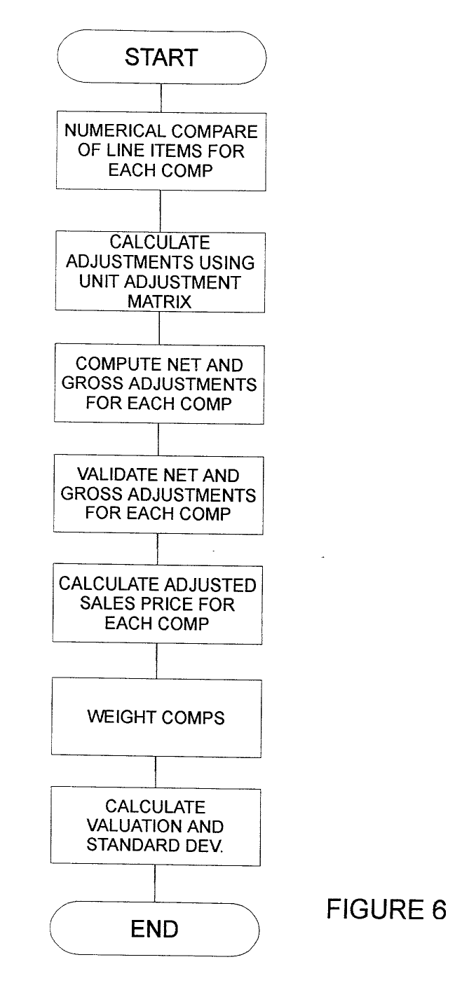

FIG. 7 is an exemplary output screen that may be provided to the user in order to display valuation and other output information according to the teachings of the present invention.

### DETAILED DESCRIPTION OF THE PREFERRED EMBODIMENTS

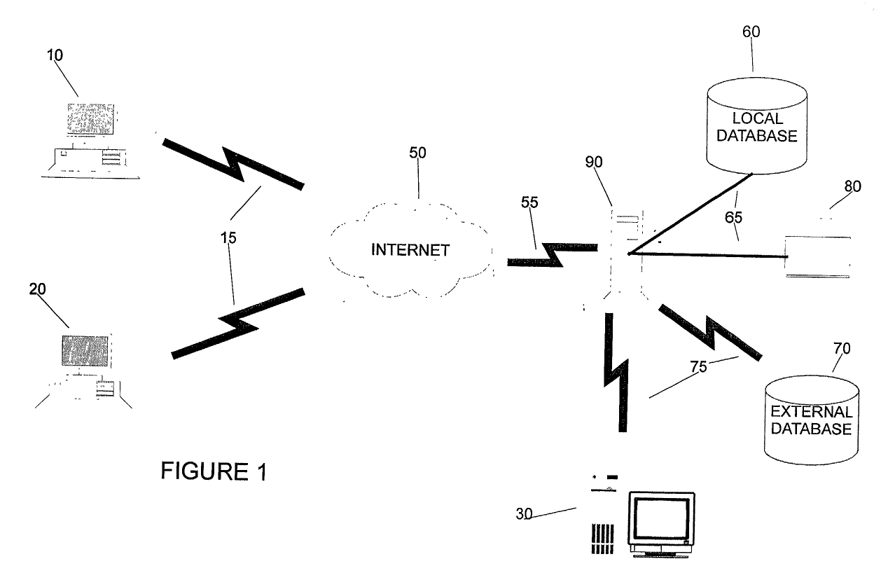

FIG. 1 is a diagram illustrating the components of the present invention in one possible configuration. According to the teachings of the present invention, the methodologies may be practiced by implementing the system of the present invention using computer software in one of a variety of computing platforms and environments. In the FIG. 1 example, users at computers 10 and 20 may access the functionality of the present invention via communication links 15. Computers 10 and 20 may be personal computers, dumb terminals or any other device capable of electronically communicating, accepting input from a user and/or providing output to a user. As will be immediately recognized by one of skill in the art, there may be many more than two computers which provide user access points into the system. Communication links 15 may represent internet service provider (ISP) access to internet 50. Server 90 may communicate through internet 50 by virtue of communications link 55.

In one preferred embodiment of the present invention, a software application which performs the valuation function according to the methodologies discussed herein is resident on server 90. Server 90 may be a personal computer or any other computing platform capable of executing software code. According to the teachings of the present invention, various databases are employed in connection with the storage and retrieval of data which is employed in the valuation process. These databases may include local databases 60 and external databases 70. Local databases 60 may be implemented through a database application and data may be stored either immediately on a hard drive or some other storage device associated with server 90 or local databases 60 may be a separately accessible and/or physically remote device. In any event, if necessary, communication lines 65 permit data exchange between local databases 60 and the software applications running on server 90. Of course, the system of the present invention may include multiple local databases which may be implemented in various manners and in various combinations.

External databases 70 may, in fact be multiple databases which make available various classes of data to the software application which implements the methodologies of the present invention. External databases 70 may be vendor or third party databases which contain data useful or necessary in connection with the valuation process. For example, various Multiple Listing Service(MLS) databases may comprise external databases 70 such that data available through such databases may be made available to the software application via a communication link 75. In addition to MLS databases, other databases, such as public record databases or any other database offering information which may be helpful in the valuation process according to the teachings of the present invention, may also be incorporated into the system of the present invention.

In one preferred embodiment of the present invention, the system may also contain one or more “administrator” terminals 30. These administrator terminals 30 may be personal computers, dumb terminals or any other device capable of communicating electronically with server 90. Communication may be directly through communications link 75. Alternatively, although not shown in FIG. 1, communication may also be accomplished through internet 50. As will be discussed in greater detail below, administration terminals 30 may be made available in the system of the present invention in order to provide another form of access for a class of user which is different from the class of users accessing the system via computers 10 and 20. For example, if the users that access the system via terminals 10 and 20 are loan origination officers working for a bank, a vice president or other senior or specialized bank employee may access the system via administration terminal 30 in order to perform tasks not available to the loan origination officers. For example, lending guideline, and in particular, appraisal guideline changes may be made only through an administration terminal 30 and not through computers 10 and 20. Additionally or alternatively, administration terminals 30 may be the access points used by system administration personnel in order to maintain, update and customize the operation of the system including the software application resident on server 90.

As will be understood by one of skill in the art, there may be multiple administration terminals 30 and also, security protocols such as password access, etc. rather than or in addition to a separate access device may be used to control access to administrator level functions within the system.

The system may also include one or more output devices 80 such as a printer for printing reports at a central location which may or may not be at the same location as server 90. Output device communicates with server 90 via communication line 65. In addition to reporting at a central location via output device 80, it is preferable that computers 10 and 20 and administration terminals 30 have report output capabilities.

As may be understood by one of skill in the art, the above configuration for the system of the present invention represents an Application Service Provider (ASP) configuration or something similar to what is commonly known as an ASP implementation. In other words, rather than locating the software application on various and multiple computing platforms such as computers 10 and 20 locally, there is generally a single copy of the software application which may be resident remote from the user terminals and which is accessed by multiple users. Of course, this is by no means the only implementation. It is also possible to implement the valuation process of the present invention in an almost unlimited number of configurations including, for example, installing individual copies of the software application on multiple personal computers with or without data sharing among and between the personal computers. However, various advantages including access to data generated by each individual valuation by all users is obtained only through some form of networking or the use of the ASP or similar deployment.

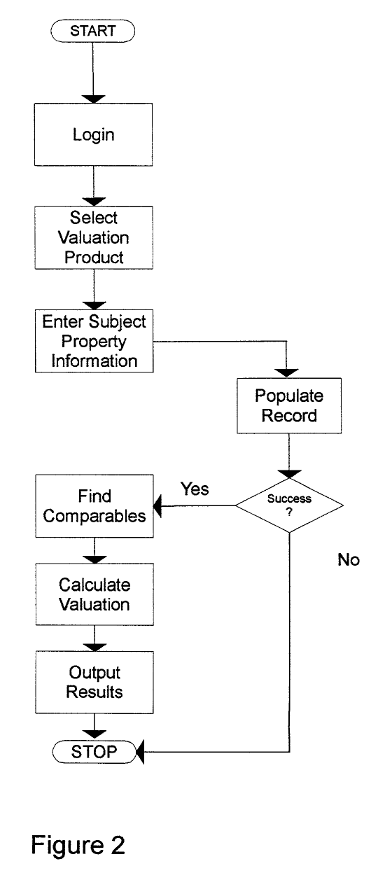

FIG. 2 is a flowchart illustrating, at a broad level, the overall process that the system of the present invention employs in order to generate a valuation for a specific subject property. The discussion which now immediately follows and is provided in connection with FIG. 2 represents a high level view of the operation of the system of the present invention. Following this general description, additional details will be provided with respect to each of the major steps associated with the overall process.

Initially, upon invocation of the process of the present invention for determining a valuation, a user is preferably requested to enter login information (LOGIN step in FIG. 2). This may be a user id, a password or both or any other authentication information. Although not a preferred embodiment, this step may be skipped and no user authentication may be required. In the preferred embodiment, some form of user authentication is required and various levels of authority with respect to use of the system may be implemented based upon user ids or one or more other user characteristics as is known in the art.

The next step in the process is for the user to select a valuation product (SELECT VALUATION PRODUCT step in FIG. 2). According to the teachings of the present invention, various valuation products may be made available to users. One valuation product may be represented by the system of the present invention. In addition, once the user selects the desired valuation product, the user may be asked to make various additional choices prior to the valuation system of the present invention being invoked. For example, assuming the user is a lender employee (e.g. a loan origination officer at a bank), the employee may, in the SELECT VALUATION PRODUCT step, select the valuation system of the present invention. Following selection of the system of the present invention, the employee may be asked to select between and among various valuation criteria to be used by the system in calculating a valuation. As will be explained in greater detail below, the valuation criteria may vary depending upon the loan program that is involved. For example, some loan programs may require the use of 3 comparables while others may require the use of more or less than 3 comparables in performing the valuation. This, and additional criteria may be supplied to the system by the user during this step as will be explained in much greater detail below.

In the next step in the overall process (the ENTER SUBJECT PROPERTY INFORMATION step in FIG. 2), the user is prompted to enter information which may be used by the system to identify the subject property which is to be valued. Various information may be used to identify the subject property depending upon the particular lookup databases (local databases 60 and external databases 70 from FIG. 1) that are available to the system. For example, the user may enter a street address, a property id number, a tax record property reference or some other identifying information. Based upon the entered information, the system next identifies the subject property and populates property information fields as is described in greater detail below. This aspect of the process is referred to herein as the POPULATE RECORD step. If the system can not obtain the required information about the subject property which is necessary to process the valuation, the process terminates and the user is preferably provided with an appropriate message alerting him or her to the reason that a valuation can not be determined.

If the subject property record can be adequately populated, the next step in the overall process is the FIND COMPARABLES step. After comparables for the subject property have been found, the valuation process continues with the CALCULATE VALUATION step and then the valuation results are made available to the user in the OUTPUT RESULTS step. As will be explained in greater detail below, there are various ways that the valuation may be reported in connection with the OUTPUT RESULTS step. For example, the valuation information may be printed out at a local or remote printer or it may be electronically transmitted via e-mail or through other protocols to one or more relevant individuals or companies.

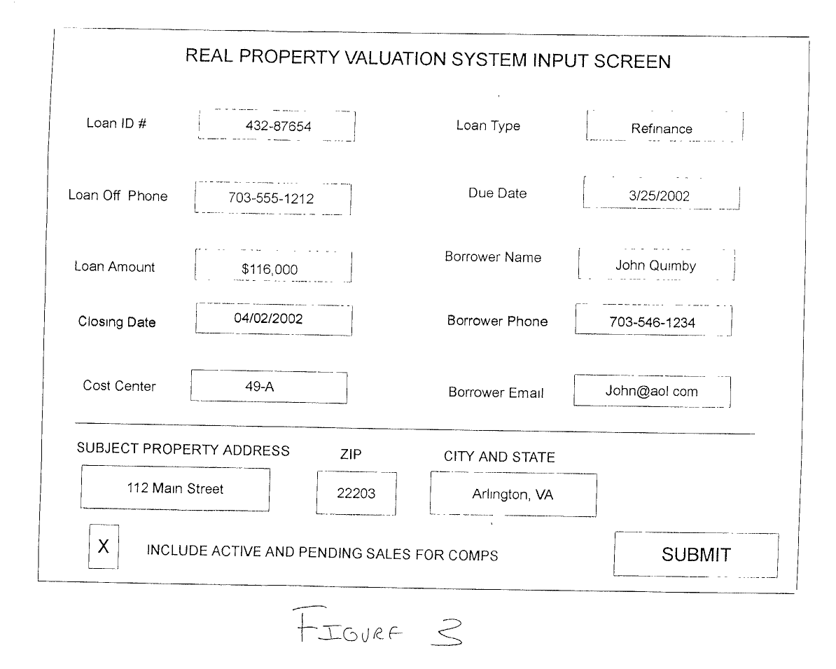

FIG. 3 is an example of a possible screen that a user may be presented with in connection with the valuation process and the input needed therefore. In particular, the user is prompted for this information during the ENTER SUBJECT PROPERTY step of the overall process. As can be seen, the user is prompted to provide various information, some or all of which may be required for processing to continue. In a preferred embodiment of the present invention, the system prompts the user for the following information:

1. Subject property address; and

2. Subject property zip code

The system may also prompt the user for record-keeping data such as the borrower's first and last name. If the user does not know or does not wish to enter the property zip code, alternatively, the user may enter the property city and state in place of the zip code.

Preferably, once received, the system will validate and standardize the input address. In other words, prior to submitting the query, the system may make a preliminary determination as to whether the address was entered in the correct format. Further, the system will insure that the address entered exists within the city and state or zip code area that was entered. The system may also do further parsing and data processing as is known in the art prior to submitting the query to the database. Further, it will be understood by one of skill in the art, that this information may be obtained by the system in the ENTER SUBJECT PROPERTY INFORMATION step via direct and interactive user input or via a batch process, the latter case permitting the processing of multiple valuations as part of a single batch.

Based upon the above input provided by the user, the system will move to the POPULATE RECORD step during which time it will compare the standardized input address and zip code data which is entered for the subject property to subject property records contained in local databases 60 and external databases 70. In a preferred embodiment of the present invention, comparison is made at least against one or more MLS databases which may be selected based solely upon zip code. For example, if the zip code entered is 22203, the system, using a look-up table will query the Northern Virginia regional MLS database. Other databases which may also be used to populate fields for the subject property record include public record databases and appraisal record databases based upon human-conducted appraisals as well as other sources of data which are available. Further, the system of the present invention may rely on the knowledge base databases as described below.

Also, in a preferred embodiment, the system will search all listing types (e.g. Pending and Closed) for the subject property. In this way, if the subject property has been sold in the past, data regarding the property may be obtained. For example, when querying MLS databases, active, pending and closed listings are typically maintained for at least 3 years following the transaction date. If more than one MLS listing is available for a subject property, the system will use the last sale data in populating the subject property record which is used for valuation.

The following table indicates exemplary fields which may be contained within the subject property record in connection with valuation. Of course, other, additional and substitute fields may be present without departing from the scope and spirit of the present invention.

TABLE I

| | |
|---|---|
| LISTING_ID | HALF_BATHS |
| LISTING_SOURCE_ID | LOT_SQFT |
| TAX_RECORD | LOT_DIM |
| MLS_NUMBER | ACREAGE |
| LISTING_STATUS_ID | DIRECTIONS |
| LISTING_VALID_TYPE_ID | CARPORT_SPACES |
| PROPERTY_TYPE_ID | GARAGE_SPACES |
| ADDRESS_PRE_DIRECTION | CONSTRUCTION_TYPE_ID |
| ADDRESS_STREET_NAME | HEATING_SYSTEM_TYPE_ID |
| ADDRESS_SUFFIX | COOLING_SYSTEM_TYPE_ID |
| ADDRESS_POST_DIRECTIONAL | POOL |
| ADDRESS_STREET_NUMBER | FIREPLACES |
| ADDRESS_SUITE | ROOF_TYPE_ID |
| ADDRESS_SUITE_NUMBER | FOUNDATION_TYPE_ID |
| CITY | LISTING_DATE |
| COUNTY | EXPIRATION_DATE |
| ZIP | TAXES |
| ZIP_EXT | TAX_YEAR |
| SUBDIVISION | CLOSING_DATE |
| LEGAL_DESCRIPTION | ORIGINAL_PRICE |
| LATITUDE | BARN |
| LONGITUDE | FENCE |
| LIST_PRICE | GREENHOUSE |
| LAST_SALE PRICE | PATIO_DECK |
| LAST_SALE_DATE | SPA |
| YEAR_BUILT | SPRINKLER |
| BUILDING_SQFT | STORAGE |
| BASEMENT_FIN_SQFT | TENNIS |
| BASEMENT_UNFIN_SQFT | WATERFRONT |
| LISTING_STYLE_ID | WATERVIEW |
| STORIES | GOLF_COURSE_LOT |
| BEDROOMS | WORKSHOP |
| FULL_BATHS | STATE |

In a preferred embodiment of the present invention, the following minimum fields are required to be obtained from the collective databases available to the system:

Address

zip

Property Type (SFR, Condo, Townhome etc)

Year Built

Number of Bathrooms

Number of Car Spaces (Garage or Carport)

Number of Fireplaces

Living Square Footage or # of Bedrooms

Basement Square Footage if any

Last Sale Date

Last Sale Price

Pool—Yes or No

Patio/Deck—Yes or No

Sprinkler—Yes or No

Workshop—Yes or No

Fence—Yes or No

Spa—Yes or No

According to this preferred embodiment, if no data is available for any of the above characteristics in any of the data sources, the user is provided with a message that the valuation can not be performed and the process terminates. Of course, as will be apparent to one of skill in the art, the system of the present invention may be configured such that any set of required minimum data is used. It is preferable, however, that at least some minimum required set of data be available as a pre-condition of performing the valuation.

Based upon the data available to the system in the collective local databases 60 and external databases 70, if the subject property record can not be populated with the required number of fields, the valuation process may be terminated with the user receiving a message such as “Insufficient subject property information—Valuation terminated”. The system may be customized by the user so as to specify which fields are required for the valuation process to proceed.

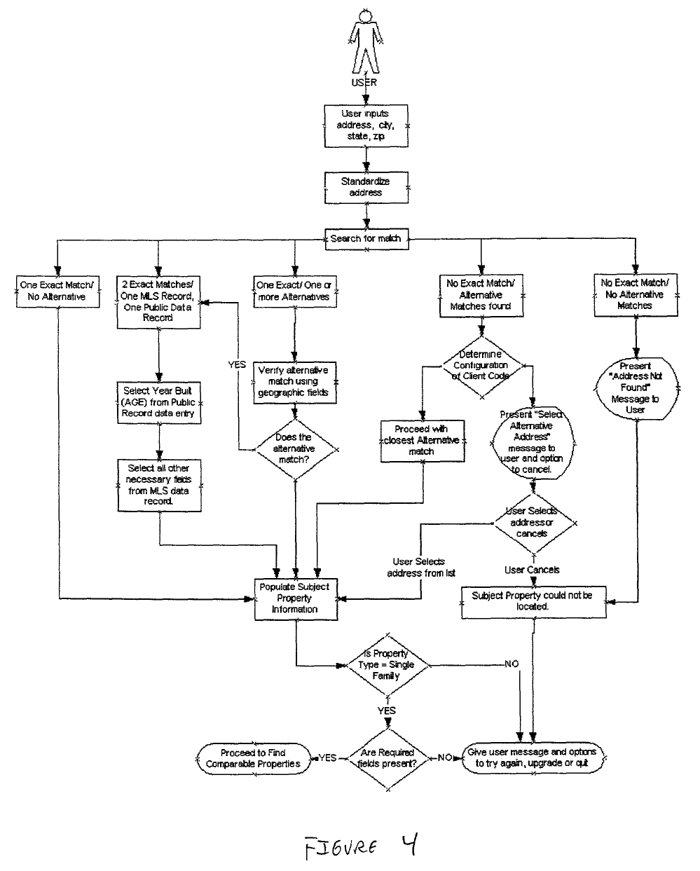

With reference now to FIG. 4, the sub-process within the POPULATE RECORD step for selecting among subject property information available to the system in the databases is now discussed. As will be understood by one of skill in the art, the sub-process described herein represents only one of a practically unlimited number of system configurations for selecting among subject property data which is available to the system, all of which may be used without departing from the spirit and scope of the present invention. Based upon user input information with respect to the subject property, there may be more than one subject property match in the databases. This is especially true in the case where multiple databases are queried such as in the case of a preferred embodiment of the present invention wherein both MLS data and public record data is accessed in order to populate subject property records in connection with the valuation process. As can be seen in the Figure once the user inputs subject property information such as street address, city, zip or some combination thereof, the information is standardized and the system searches for a match in one or more of the available databases. Taking the leftmost branch first, if one exact match is found and there is no alternative match, the subject property record is populated from the matching record and the process moves to the next step.

In one embodiment of the invention, the next step may be to determine, from the matching data whether or not the property is a single family home. According to one embodiment of the present invention, if the property is not single family, a valuation is not performed. In this case, a user message is provided and processing terminates. Of course, the system, if configured as such can process valuations, in an alternative embodiment, for non-single family properties such as condominiums, townhouses, etc. If the property is single family or if the property is not single family but the system is configured to value non-single family properties, the next step is to determine comparables. This aspect of the process is discussed in greater detail below.

Returning to the top of the flowchart in FIG. 4, if two exact matches are found and one is from an MLS database and another is from a public record database, the year of construction is extracted from the public record database with all of the remaining data being extracted from the MLS databases. Once this is done, the subject property record is populated with the data and the process continues as discussed above.

In a preferred embodiment of the invention, as described above, subject property address information which is input by the user is standardized. For this reason, in a preferred embodiment of the invention, when querying the available databases for the subject property, either exact matches are returned or no match is returned. As such, no user input is solicited with respect to asking the user to decide between possible alternative matches returned. However, as can be seen in FIG. 4, another embodiment of the invention operates so that when multiple possible addresses are returned, possible alternative matches may be displayed for the user who may be asked to decide among such alternative matches.

If one exact match is located in the databases and one or more alternative matches are also located, and the system is operating to permit alternative matches, the process proceeds as follows. First, the system compares the alternative match record(s) to the exact match record using geographic coding fields such as latitude and longitude fields in order to determine if the one or more alternative match record(s) matches the exact match record. A matched pair must consist of one MLS record and one Public Data record. If a matched pair is located, the system populates data from the matched records as discussed above (the case where there are two exact matches, one public record and one MLS record). If no matched pair exists, the system populates the subject property record using data from the exact match record and the process continues from there.

If there is no exact match found but there are one or more alternative matches found, the process proceeds as follows. Depending upon the-configuration of the system as configured by the user either ahead of time or in “real time” interactively in response to a system prompt, the system may proceed according to option I or option II. In the case of option I, each of the alternative matches will be displayed for the user and the user will be prompted to select one of the alternative matches for populating the subject property record. Alternatively, the user may terminate the process and possibly enter a new address for processing. In the case of option II, the system will proceed with the closest match without additional user input. Option II is preferably always used in the case of batch processing of properties for valuation.

In the final case, there are no exact matches and no alternative matches found. In this case, the system notifies the user with a message indicating that the subject property could not be found in any of the available databases.

Once the ENTER SUBJECT PROPERTY INFORMATION and POPULATE RECORD steps have been completed as described above and, assuming that the POPULATE RECORD step was a success, the process proceeds to the FIND COMPARABLES step. The FIND COMPARABLES step consists of primarily of finding one or more comparables to use in connection with the valuation of the subject property. It is this aspect of the overall process which is now described.

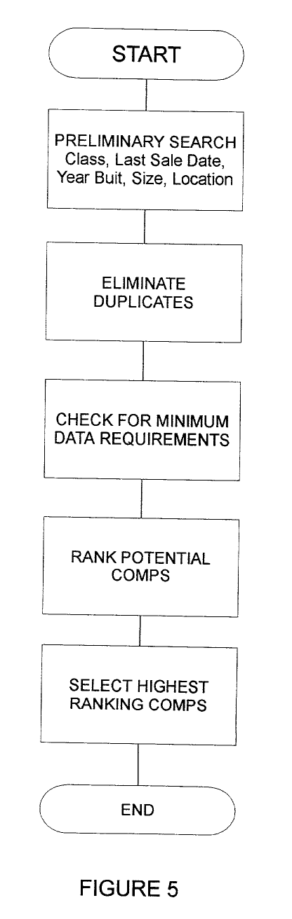

FIG. 5 is a flowchart which illustrates the major sub-processes within the FIND COMPARABLES step. The purpose of the FIND COMPARABLES step is to select appropriate comparable properties for use in valuing the subject property. In addition to the case where the required number of appropriate comparables are found there exist alternative cases such as when no or not enough appropriate comparables are found or when “pending sale” comparables are selected. Each of these cases must be handled in connection with the overall process flow of the FIND COMPARABLES step of the present invention. For purposes of the description herein, it is assumed that located comparables are sourced from either MLS databases, Public Record databases or a combination of both. It is preferable that all databases, whether external or local, are searched to find comparables even if this results in the location of duplicates. Duplicates are dealt with as discussed below. Those of skill in the art will recognize that the process flow described herein may be applied in the case where additional and/or alternative databases and employed in arriving at a valuation.

Initially, upon beginning the FIND COMPARABLES step, in a preferred embodiment of the present invention, the system searches for comparable properties meeting the following requirements:

1. Subject Property Class=Comparable Property Class

For example, both properties should be of the same class such as townhouse, condo, manufactured housing, rental, single family home, etc.

2. Last Sale Date of Comparable less than 12 months old

For example, the system may be configured so as to only use comparables that sold less than one year ago.

3. Year Built within 7 years

For example, the year that the comparable property was built should be within 7 years of the date that the subject property was built.

4. Size within 18%

For example, the comparable property's square footage should be within 18% plus or minus of the square footage for the comparable. If the square footage is not available in both records, then the comparable property's number of bedrooms should be within 1 plus or minus of the subject property's number of bedrooms.

5. Location radius within 0.5 miles from the subject property

For example, comparables should only be accepted for valuation purposes if they are within a 0.5 mile radius of the subject property. Various methods for determining distance may be used. For example, driving distance or “as the crow flies” are two possible methodologies for determining distance between comparables and subject properties.

Of course, various other criteria and limitations may be used in selecting comparables without departing from the scope and spirit of the present invention. For example, other tests such as number of bathrooms, exterior construction etc may be used and limits may be tightened or relaxed. For example, the location radius may be loosened to require only that comparables be within, for example, 5 miles from the subject property. All of these criteria and limits may be set and configured by the user depending upon the particular loan program requirements.

Once all databases from which comparable sources have been queried and possible comparables which meet the above referenced or other set criteria have been identified, the system preferably checks the pool of selected potential comparables for duplicate or matching records and combines all resulting information from the records to create a collective Comparable Property record. For example, duplicate or matching property records may occur with respect to a property which has been sold multiple times in the past year or if the same property is referenced in both MLS and public record databases. In the event of duplicates, it is preferable that that the record with the most recent sale date is used whether the record comes from MLS or from public data. In the case where there is both an MLS record and a public data record for the same comparable property, the system preferably uses the Year Built field from the public record database and all other comparable record fields from the MLS database. Any fields for which there is no data in the MLS record may be populated using information which may be available thought the public record database.

Once the comparables have been potentially selected and duplicate records have been located and combined as discussed above, the system preferably checks each of the comparables to ensure that their respective populated records contain the minimum required set of data. This minimum set of required data may be controlled and configured by user input, again depending upon lender and specific loan program requirements with respect to valuation procedures.

In a preferred embodiment of the present invention, comparables are selected for use only if they contain the following required fields:

1. Address

2. Year Built

3. Bathrooms—number of

4. Bedrooms—number of

5. Carport—number of cars

6. Deck—yes or no

7. Fence—yes or no

8. Fireplaces—number of

9. Foundation description

10. Garage—Number of spaces

11. Last Sale Date

12. Last Sale Price

13. Pool—yes or no

14. Patio/Porch—yes or no

15. Property Class—single family, townhouse, condo, rental, etc.

Based upon the above, if a potential comparable record does not contain valid information for each of the following fields, it is excluded from use in the valuation calculation. Of course, other and additional requirements for comparable data presence may be specified without departing from the scope or spirit of the present invention.

Once the universe of potential comparables has been determined, the system ranks the potential comparables according to the following criteria. The highest ranking is given to comparables that are classified as “closed” meaning that a property has been contracted for, and presumably the sale and closing have taken place. According to a preferred embodiment of the invention, comparables that have any other classification (e.g. “active” meaning that a property is currently being listed for sale but has not yet sold or “pending” meaning that a property has been contracted for but the transaction has not yet closed) are not used in determining the valuation unless specifically permitted by the user. Again, the necessary configuration for selection of criteria for appropriate comparables may be accomplished by the user interactively during the valuation processing. Alternatively, the system may be pre-configured with some or all of the comparable selection criteria or the criteria may be determined automatically by associating particular loan programs with or lenders with particular sets of criteria. For example, when a user is seeking a valuation in connection with Loan Program A, valuation criteria associated with that loan program may be used in the process, while if the user specifies that the valuation is in connection with Loan Program B or another lender, another set of criteria may be called up and used by the system of the present invention in selecting comparables.

Continuing with the discussion of comparable ranking, highest priority is also given to comparables within the same subdivision as the subject property if the subdivision information is available for both the subject property and the comparable property. If subdivision information is not available or if there are multiple or no potential comparables within the same subdivision as the subject property, the system uses the proximity between each comparable and the subject property as a ranking methodology. Various distance calculations can be used. For example, straight line (“as the crow flies”) distance calculation may be calculated as follows:

Latitude and Longitude in Radians—

A = LAT1, B = LONG1
C = LAT2, D = LONG2
DISTANCE = 3963.1 * ARCO[SIN(A)SIN(C) + COS(A)COS(C)COS(B − D)]

DISTANCE=3963.1*ARCOS[SIN(A)SIN(C)+COS(A)COS(C)COS(B−D)]

Once distance between properties has been determined, the ranking may be based upon a tier structure as follows:

Distance from Subject

Subdivision - same?
Straight-line distance

Tier 1 − 0 to 0.15 miles
Tier 2 −> 0.15 to 0.30 miles

Tier 3 −> 0.30 to 0.5 miles

Potential comparables are preferably also be ranked by similarity in Year Built to the subject property Year Built as follows. The following tiers based upon the age differences between the properties may be used.

Difference in Year Built from subject
Tier 1 - Difference of 0-1 years
Tier 2 - Difference of 2-3 years
Tier 3 - Difference of 4-5 years
Tier 4 - Difference of 6-7 years

Of course, other ranges and tier structures may be used based upon user requirements.

Potential comparables are preferably also ranked by similarity in Square Footage according to the following. If Square Footage is not available in either the subject property record or in the applicable comparable records, comparables with the same number of bedrooms as the subject property are given the highest ranking. Otherwise, if Square Footage is available, the comparables with the Square Footages closest to that of the subject property are prioritize in terms of the difference in Square Footage with the comparables being closest in Square Footage to the subject property given highest ranking. The following tier structure based upon square footage difference between the subject property and the comparable may be used:

Difference in Size from subject Square Footage

Tier 1 - Difference </= 3.0% from Subject Property's SQFT
Tier 2 - Difference is > 3.0% and < /= 10.0% from Subject Property's
SQFT
Tier 3 - Difference is > 10.0% and < /= 18.0% from Subject
Property's SQFT

Of course, other ranges and tier structures may be used based upon user requirements.

Comparables are also preferably ranked by date of last sale with the comparables having the most recent date of last sale being given the highest ranking. Further, comparables are also preferably ranked by design elements (e.g. Lot Description, Exterior Description, Style Description, and Number of Stories fields) with those comparables with characteristics most similar to the subject property being given the highest ranking.

Comparables may also be ranked according to other property elements. These elements include Foundation Description, Bedroom Count, Bathroom Count, Garage Description, Garage-Number of Spaces, Carport Description, Carport—Number of Cars, Roof Description, Private Pool—YIN, Pool Area—YIN as well as other property descriptors that are available for matching between the comparable record and the subject property record. As above, comparables with elements that are most similar to that of the subject property will receive the highest ranking.

Once all comparables have been ranked as to each of the above elements based upon available data, the system, in a preferred embodiment, attempts to select the highest 6 ranked comparables. In a preferred embodiment, at least 3 comparables are needed to perform a valuation. Of course, the minimum number of comparables required to perform a valuation and the maximum number of eligible comparables which may be used in the valuation may be set by a user in connection with the configuration of the system. For example, a particular guideline, loan program or user may decide that at least three comparables are necessary to provide a valid valuation and that if there are ten or more comparables that meet the criteria described above, up to ten of those comparables may be used in determining valuation.

Preferably, once comparables are ranked as to each characteristic, overall comparable rankings as against one another are determined based upon their ranking for the most important characteristic(s) first. If they are ranked equally with respect to that characteristic, the ranking for another, less important characteristic, is used as the basis to rank the comparables on an overall basis. In one preferred embodiment of the present invention, the category order for determining overall ranking is as follows:

1. Listing Type

Closed - Highest Ranking
Pending - Middle Ranking
Active - Lowest Ranking

2. Distance from Subject

Same Subdivision - Highest Ranking
Straight-line distance

Tier 1 - 0 to 0.15 miles - 2nd Highest Ranking
Tier 2 - >0.15 to 0.30 miles - 3rd Highest Ranking
Tier 3 - >0.30 to 0.5 miles - Lowest Ranking

3. Difference in Year Built from subject

Tier 1 - Difference of 0-1 years - Highest Ranking
Tier 2 - Difference of 2-3 years - 2^{nd} Highest Ranking
Tier 3 - Difference of 4-5 years - 3^{rd} Highest Ranking
Tier 4 - Difference of 6-7 years - Lowest Ranking

4. Difference in Size from subject square footage

Tier 1 - Difference </= 3.0% from Subject Property's SQFT - Highest Ranking
Tier 2 - Difference is > 3.0% and </= 10.0% from Subject Property's SQFT - Middle

Ranking

Tier 3 - Difference is > 10.0% and </= 18.0% from Subject Property's SQFT - Lowest

Ranking
5. Date of Sale

Ranking given by order of sale date with most recent sale date receiving highest ranking

6. Design - a match receives a higher priority than a non-match

Listing_Style_Id match -
Stories match
Construction_Type_Id match
Foundation_Type_Id match
Roof_Type_Id match

7. Other Property Elements - a match receives a higher priority than a non-match

Bedroom Count
Bathroom Count
Garage Spaces
Carport Spaces
Pool
Fence
Sprinkler
Spa
Workshop

An example is now provided in order to illustrate how comparable properties are ranked against one another on an overall basis after rankings for individual characteristics have been determined. The example is provided in connection with Table 2, below. The table includes the subject property in the top row with each of the potential comparables in the rows below. In this case, nine properties have a subdivision match, so they are moved to the top of the rankings list. Of those nine properties, four are tier 1 for Distance, so those four are moved to the top within the overall total of nine. Within the four comparables meeting the Distance Tier 1 requirements, only one property has a year built tier of 3, so it is moved to the top within the four that meet the subdivision match. The other three have a year built tier of 5 and all three have a SQFT tier of 3, so they are placed in order by most recent Last Sale Date. In the event that there are properties that have all four of these criteria in common (including last sale date), then property characteristics are taken into account as listed above.

As will be understood by one of skill in the art, the above described overall ranking process is not the only possible methodology. Many other overall ranking methodologies may be used without departing from the scope or spirit of the present invention. For example, it is possible to sum all of the “tier numbers” to arrive at one number that indicates likeness to the subject property. In this case, the lower this “sameness” number, the better the comparable and the higher ranking that it receives.

TABLE 2

| | | ADDRESS_ | ADDRESS_ | | | | SUB- | |
|---|---|---|---|---|---|---|---|---|
| | LISTING_ | STREET_ | STREET_ | ADDRESS_ | | | DIVISION | |
| LISTING_ID | STATUS_ID | NUMBER | NAME | SUFFIX | ZIP | SUBDIVISION | Match? | DISTANCE |
| 10244464 | SOLD | 823 | MOROCCO | AVE | 32807 | DOVER SHORES | | 0 |
| 1107201 | SOLD | 4700 | FONTANA | ST | 32807 | DOVER SHORES | 1 | 0.061346 |
| | | | | | | | | 191 |
| 1039022 | S0LD | 1200 | CORBETT | LN | 32806 | DOVER SHORES | 1 | 0.378895 |
| | | | | | | | | 131 |
| 1095044 | SOLD | 4621 | LARADO | PL | 32812 | DOVER SHORES | 1 | 0.377228 |
| | | | | | | | | 296 |
| 1034703 | SOLD | 4700 | ARCIE | ST | 32812 | DOVER SHORES | 1 | 0.380918 |
| | | | | | | | | 735 |
| 1101181 | SOLD | 4309 | DEVON- | LN | 32812 | DOVER SHORES | 1 | 0.699960 |
| | | 4309 | SHIRE | LN | | | | 673 |
| 1027037 | SOLD | 1229 | BERWYN | RD | 32806 | DOVER SHORES | 1 | 0.733264 |
| | | | | | | | | 188 |
| 1019269 | SOLD | 4530 | LARADO | PL | 32812 | DOVER SHORES | 1 | 0.533781 |
| | | | | | | | | 489 |
| 1104603 | SOLD | 1500 | CATALPA | LN | 32806 | DOVER SHORES | 1 | 0.840740 |
| | | | | | | | | 333 |
| 1059986 | SOLD | 1406 | ROSCO- | AVE | 32806 | DOVER SHORES | 1 | 0.640414 |
| | | | MAR | | | | | 45 |
| 1095056 | SOLD | 807 | MOROCCO | AVE | 32807 | DOVER SHORES | 2 | 0 |
| | | | | | | 14TH AD | | |
| 1085506 | SOLD | 571 | ROSE- | AVE | 32807 | MONTEREY SUB | 2 | 0.339710 |
| | | | MONT | | | UNIT 5 | | 831 |
| 1076222 | SOLD | 430 | SANTIAGO | AVE | 32807 | MONTEREY | 2 | 0.415409 |
| | | | | | | | | 952 |

| | DIS- | | YEAR | YEAR | | | | |
|---|---|---|---|---|---|---|---|---|
| LISTING_ | TANCE | YEAR | BUILT | BUILT | BUILDING_ | SQFT | SQFT | LAST_ |
| ID | TIER | BUILT | Diff. | TIER | SQFT | DIFF. % | TIER | SALE_DATE |
| 1024464 | 1 | 1968 | | | 1582 | | | Sep. 30, 1999 |
| 11027201 | 1 | 1964 | 4 | 3 | 1519 | 0.039823 | 2 | Jun. 29, 2001 |
| | | | | | 009 | | | |
| 1039022 | 1 | 1958 | 10 | 5 | 1790 | 0.131479 | 3 | Nov, 14, 2001 |
| | | | | | 14 | | | |
| 1095044 | 1 | 1960 | 8 | 5 | 1369 | 0.134539 | 3 | Aug. 24, 2001 |
| | | | | | 697 | | | |
| 1034703 | 1 | 1959 | 9 | 5 | 1910 | 0.207332 | 3 | May, 31, 2001 |
| | | | | | 491 | 3 | | |
| 1101181 | 2 | 1958 | 10 | 5 | 1458 | 0.078381 | 2 | Oct. 29, 2001 |
| | | | | | 795 | | | |
| 1027037 | 2 | 1958 | 10 | 5 | 1524 | 0.036662 | 2 | Sep. 28, 2001 |
| | | | | | 453 | | | |
| 1019269 | 2 | 1959 | 9 | 5 | 1478 | 0.066739 | 2 | Sep. 27, 2001 |
| | | | | | 57 | | | |
| 1104603 | 2 | 1959 | 9 | 5 | 1370 | 0.134007 | 3 | Aug. 6, 2001 |
| | | | | | 585 | | | |
| 1059986 | 2 | 1958 | 10 | 5 | 1272 | 0.195954 | 3 | Mar. 19, 2001 |
| | | | | | 488 | | | |
| 1095056 | 1 | 1968 | 0 | 1 | 1582 | 0 | 1 | Aug. 10, 2001 |
| 1085506 | 1 | 1970 | 2 | 2 | 1540 | 0.026548 | 1 | Aug. 22, 2001 |
| | | | | | 673 | | | |
| 1076222 | 1 | 1963 | 5 | 3 | 1430 | 0.096080 | 2 | Aug. 5, 2007 |
| | | | | | 91 | | | |

As will be apparent to one of skill in the art, other configurable ranking methodologies may be used without departing from the scope or spirit of the present invention. For example, overall ranking may be based on a weighted average of the rankings for each of the characteristics. Other schemes are also possible. Additionally, “bracketing” requirements may be factored into comparable selection and eligibility. In some cases, depending upon lending requirements, such as the Fannie Mae guidelines, the comparables that are selected for inclusion in the valuation calculation must “bracket” the subject property with respect to pre-determined characteristics. For example, if the subject property has a square footage of 2500 square feet and three comparables are used, the system may be configured to require that at least one of the comparables have a square footage of greater than 2500 and at least one of the comparables have a square footage of less than 2500.

In one embodiment of the present invention, it is possible that one or more “outlier” comparables may be discarded prior to proceeding to the CALCULATE VALUATION step. Whether or not these outlier comparables are examined and possibly discarded is may be set by the user in connection with the configuration process or the product itself may be preset with respect to whether or not this “outlier discard” step is included in the overall process. In the event outliers are to be discarded, this aspect of the process proceeds as follows.

In general, Properties with Last_Sale_Price defined as an Outlier using the Last_Sale_Price of all conforming properties as a dataset are discarded and are not used in the valuation calculation. Outliers are determined as follows. If n is the number of properties in the population,

Median

If n is odd, this is the sales price of the property in the middle (50% of the properties will be above this price and 50% below).

If n is even, the median is halfway between the Last_Sales_Price of the two properties in the middle of the population.

Quartile 1 (Q₁ or 25^{th} percentile)

If n is even, the first quartile, Q₁, is the median of the smallest n/2 observations. If n is odd, Q₁ is the median of the smallest

$$\frac{( n - 1 )}{2}$$

observations.

Quartile 3 (Q₃ or 75ₜₕ percentile)

If n is even, the third quartile, Q₃, is the median of the largest n/2 observations. If n is even, the third quartile, Q₃, is the median of the largest

$$\frac{( n - 1 )}{2}$$

observations.

Inter-quartile Range (IQR)

IQR=Q₃−Q₁

Outlier

Outliers are defined as properties with Last_Sale_Price>(1.5*IQR) above Q₃ or (1.5*IQR) below Q_{1.}

### EXAMPLE

With the following population, the following calculations result:

| | | |
|---|---|---|
| 305000 | Mean | 384299.5 |
| | Median | 360000 |
| 330000 | Q1 | 337500 |
| | Q3 | 390500 |
| 335000 | IQ range | 53000 |
| 340000 | 1.5 IQ range | 79500 |
| | Outlier low | <258000 |
| 340000 | | |
| 360000 | | |
| 365000 | | |
| 385000 | | |
| 396000 | | |
| 499000 | | |
| 572294 | | |

As will be recognized by one of skill in the art, the definition of statistical outlier may be adjusted to use a different multiplier for the Inter-quartile Range (i.e. (1*IQR) instead of (1.5*IQR).

As an alternative, another definition of ‘outlier’ that may be employed when the subject property record has last sale price information populated by a MLS record is to calculate a range whithin which all comparable properties must fall. This range may be calculated as a ±% variance from the subject property's prior sales price. The percentage will be determined in part by the age of the subject property record, and it will be in accordance with the methods used by appraisers for selecting comparable properties based in part on prior sales history. Other information, which may be used in this step and elsewhere in the valuation, is an appreciation/depreciation factor for a market over time. This appreciation/depreciation factor would be obtained from analysis of repeat sales within the MLS database. The appreciation/depreciation factor may be used to adjust the prior sales price of the subject property depending on the age of the subject property record.

Once the comparables have been selected as a result of the FIND COMPARABLES step (possibly including discard of outliers as discussed above), the overall process of the present invention proceeds on to the CALCULATE VALUATION step which is now described. The flow is described in terms of one Comparable Property, but it should be understood that the process is repeated for each Comparable Property. In a preferred embodiment of the present invention, each Comparable Property's Last Sale Price is adjusted up or down using comparison adjustments as described below.

When the system initiates the CALCULATE VALUATION step it first performs a comparison of line items. The system compares the following subject property elements to the corresponding comparable property line item in order to calculate the numerical difference between each analogous line item.

Number of bathrooms
Square Footage (Gross Living Area)
Basement Finished
Basement Unfinished
Garage Number of bays
Carport number of bays
Workshop
Patio/Porch - TBD
Spa - TBD
Sprinkler - TBD
Fireplace
Fence - TBD
Pool (In ground only)

When Square Footage is not available in either of both of the comparable and/or subject property records, the system will compare the Number of Bedrooms field.

Number of Bedrooms*

When Basement information is not available, the system preferably assumes a value of 0 for the Basement Finished and Basement Unfinished fields. For each field listed, the numerical difference between the comparable property and the subject property is calculated and stored. The numerical difference is expressed as a positive or negative number and serves as a multiplier for determining the dollar amount for each adjustment as described in greater detail below. The Adjustment Unit for “Number of Bathrooms” is “½baths”. The numerical difference must be converted into the ½bath unit by dividing by 0.5.

The following table provides an example of the numerical differences which may be generated by the system on a line item by line item basis in comparing the subject property to each of the comparable properties. Note that for Yes/No line items, either a one or zero is used to represent yes and no, respectively.

TABLE 3

| Property Line Item | Subject Property | Compatable 1 | Difference |
|---|---|---|---|
| Last Sale Price | Unknown (Price_{subject}) | 276,000 (Price_{Comp1}) | tbd |
| Last Sale Date | N/A | Nov. 16, 2000 | N/A |
| Number of Bedrooms | N/A | N/A | |
| Number of bathrooms | 3 | 2.5 | +.5 |
| | | | (Convert to ½ bath unit) = 1 |
| Gross Living Area | 2800 | 2475 | +325 |
| Basement finished sq. ft. | 0 | 1850 | −1850 |
| Basement unfinished sq. ft. | 0 | 0 | 0 |
| Garage Number of bays | 2 | 2 | 0 |
| Carport number of bays | 0 | 0 | 0 |
| Porch | 0 | 0 | 0 |
| Patio | 1 | 1 | 0 |
| Deck | 0 | 1 | −1 |
| Fireplace | 1 | 1 | 0 |
| Fence | 0 | 0 | 0 |
| Pool (In ground only) | 0 | 0 | 0 |

This calculation is repeated for each Comparable Property.

Once the line item/field numerical values have been established as described above, the next aspect of the CALCULATE VALUATION step is for the system to determine the numerical difference for each of the line items. This is accomplished by translating into a dollar amount by multiplying the difference by the appropriate unit adjustment amount. Using the following matrix as reference, the system uses the appropriate set of unit adjustments based on the Last Sale Price of the Comparable Property.

In a preferred embodiment of the present invention, the minimum difference in Square Footage (Gross Living Area) must be at least 50 square feet for an adjustment is made for the Square Footage Line Item. Of course, this parameter as well as other parameters discussed above and below herein may be adjusted through the user configuration capabilities of the present invention such that each lender, user, or loan program may employ different guidelines and rules in connection with the valuation determination.

In a preferred embodiment of the present invention, a Unit Adjustment Amount Matrix is employed which assigns a dollar factor to be multiplied by the numerical difference figure determined as described above. Again, in a preferred embodiment, this dollar factor (Unit Adjustment) preferably varies depending upon the Last Sales Price of the comparable property being subjected to adjustment. The table below provides exemplary Unit Adjustments. Of course, each of the values may differ as determined by the user depending upon the particular requirements and guidelines of the valuation being undertaken.

TABLE 4

| | 75,000- | 125,000- | 175,000- | 225,000- | 275,000- | 325,000- | 375,000- | 425,000- | 475,000- |
|---|---|---|---|---|---|---|---|---|---|
| Last Sale Price | 125,000 | 175,000 | 225,000 | 275,000 | 325,000 | 375,000 | 425,000 | 475,000 | 525,000 |
| Value Adjustments | | | | | | | | | |
| Baths per 1/2bath | 750 | 1100 | 1150 | 1450 | 1550 | 1750 | 2050 | 2150 | 2250 |
| Gross Living Area per | 19.125 | 23.3 | 24.2 | 29.1 | 29.7 | 32.5 | 37.3 | 40.7 | 43.5 |
| sq. ft. | | | | | | | | | |
| Basement finished per | 8 | 12 | 14 | 16 | 18 | 20 | 23 | 25 | 28 |
| sq. ft. | | | | | | | | | |
| Basement unfinished per | 5 | 7 | 10 | 12 | 12 | 14 | 15 | 15 | 17 |
| sq. ft. | | | | | | | | | |
| Garage per bay | 1600 | 1750 | 2050 | 2250 | 2900 | 3400 | 3500 | 3700 | 3800 |
| Carport per bay | 850 | 950 | 1050 | 1250 | 1312.5 | 1562.5 | 1812.5 | 1812.5 | 1812.5 |
| Workshop | 1333 | 1583 | 1750 | 2083 | 2833 | 3333 | 3500 | 3500 | 3866 |
| Patio/Deck | 937.5 | 1187.5 | 1187.5 | 1312.5 | 1562.5 | 1687.5 | 1812.5 | 2312.5 | 2312.5 |
| Spa | 600 | 700 | 850 | 950 | 1050 | 1150 | 1350 | 1550 | 1550 |
| Sprinkler | 700 | 900 | 1050 | 1250 | 1500 | 1600 | 1800 | 1900 | 1900 |
| Fireplace | 750 | 1050 | 1250 | 1550 | 1550 | 1850 | 2050 | 2250 | 2350 |
| Fence | 500 | 750 | 750 | 1125 | 1187.5 | 1375 | 1687.5 | 1687.5 | 1812.5 |
| Pool (In ground only) | 4875 | 6125 | 7000 | 8000 | 10375 | 11625 | 14500 | 16875 | 16875 |

As described above in connection with the determination of numerical differences, when Square Footage data is not available in either the comparable record or in the subject property record, the system uses Number of Bedrooms instead. According to a preferred embodiment, the system calculates the numerical difference in Number of Bedrooms using the following matrix. Again, other values may be used without departing from the invention claimed herein.

TABLE 5

| | 75,000- | 125,000- | 175,000 | 225,000- | 275,000- | 325,000- | 375,000- | 425,000- | 475,000- |
|---|---|---|---|---|---|---|---|---|---|
| Last Sale Price | 125,000 | 175,000 | 225,000 | 275,000 | 325,0000 | 375,000 | 425,000 | 475,000 | 525,000 |
| VALUE Adjustments | | | | | | | | | z |
| per bedroom | 500 | 500 | 1000 | 1000 | 1250 | 1250 | 1500 | 1750 | 2000 |

Continuing the example from earlier and using the data for comparable property 1 and the subject property as contained in Table 3, line item dollar Adjustment Amounts are calculated for the sample Comparable Property.

TABLE 6

| | | | Line Item |
|---|---|---|---|
| | Difference | Unit | $ Adjust- |
| Property Line Item | (Subject Comp) | Adjustment | ment Amt. |
| Number of bedrooms | N/A | N/A | N/A |
| Number of bathrooms | +1 (½ baths) | $1500/½ bath | $1500 |
| Gross Living Area | −150 ft² | $35/ft² | +$11,375 |
| Basement finished sq. ft. | −1850 ft² | $16/ft² | −$29,600 |
| Basement unfinished sq. ft. | 0 | $12/ft² | 0 |
| Garage Number of bays | 0 | $3000/bay | 0 |
| Carport number of bays | 0 | $1500/bay | 0 |
| Basement garage # of bays | 0 | $3000/bay | 0 |
| Porch | 0 | $1500/porch | 0 |
| Patio | 0 | $1000/patio | 0 |
| Deck | −1 deck | $1000/deck | −$1000 |
| Fireplace | 0 | $1500/fireplace | 0 |
| Fence | 0 | 2000/fence | 0 |
| Pool (In ground only) | 0 | 12000/pool | 0 |

Based upon the above, a Net Adjustment for Comparable 1 may be determined by summing all line item dollar adjustment amounts.

Gross Adjustment_{Comp1}=$43,475 which is 15.8% of Last Sale Price.

Net Adjustment_{Comp1}=$−17,725 which is 6.4% of Last Sale Price.

A gross adjustment for Comparable 1 is also calculated by summing the absolute values of all line item dollar adjustment amounts.

The next aspect of the CALCULATE VALUATION STEP is to validate the amount of the Gross Adjustment for each comparable property. The amount of Gross Adjustment should preferably be less than 25% of the Last Sale Price for the comparable. Again, this restriction may be modified or eliminate based upon user or program requirements. In the case where the 25% maximum Gross Adjustment rule is used, if the Gross Adjustment is greater than or equal to 25%, then the comparable is dropped from the valuation calculation and other comparables are used assuming that based upon the rule set there are enough valid remaining comparables to perform the valuation. For example, in one embodiment, if the Comparable is dropped and the number of comparables left is less than 3, then the process is stopped and the user may be given a message such as the following.

“Unable to process valuation. The Adjustments on the available Comparable Properties exceeded Fannie Mae guidelines.”

The next aspect of the CALCULATE VALUE step is the calculation of an Adjusted Sales Price for each comparable property. This is accomplished by adding the Net Adjustment and the Last Sale Price.

Adj_Price_{Comp1}=Price_{Comp1}+Net Adjustment_{Comp1}

For example, using the data for the subject property and comparable 1 as provided above, the Adjusted Sales Price for comparable 1 is calculated as:

Adj_Price_{Comp1}=$275,000−$17,725=$257,275

The system next continues the CALCULATE VALUATION step by weighting the comparables according to the number and amount of adjustments using the following formula. As can be seen, the weight assigned to a comparable property is dependent on the total number of Comparable Properties included in the calculation.

The following are used to calculate the weight of each Comparable.

Adj_Ct_{Compx} - Number of Line Item Adjustments made on Comparable_{Compx}
Adj_Per_{Compx} - The percentage of the Gross Adjustment vs. Last Sale Price (Price_{Compx})
Distance_{Compx} - The distance of the Comparable from the Subject.
Age_of_Sale_{Compx} - The age of the sale in weeks or number of weeks prior to the current

date that the Comparable property sale closed.

Line_Items_{Compx} - Number of Line Items in the Matrix (Constant - in a preferred

embodiment, 13 may be used)

Adj_Limit_{Compx} - The allowable limit of Gross Adjustment percentage (Constant - in a

preferred embodiment 25 may be used in conformance with current Fannie Mae guidelines)

Distance_Limit_{Compx} - The allowable Distance limit, 2.0 miles.
Age_Limit_{Compx} - The allowable age limit, 52 weeks.
N = Number of Comparables in the Calculation
Adj_Ct_Inv_{Compx} = Line_Items_{Compx} − Adj_Num_{Compx}
Adj_Per_Inv_{Compx} = Adj_Limit_{Compx} − Adj_Per_{Compx}
Adj_Dist_Inv_{Compx} = Distance_Limit_{Compx} − Distance_{Compx}
Adj_Age_Inv_{Compx} = Age_Limit_{Compx} − Age_of_Sale_{Compx}
Adj_Ct_Wt_{Compx} = Adj_Ct_Inv_{Compx}/SUM(Adj_Ct_Inv_{Comp1}:Adj_Ct_Inv_{Compx})
Adj_Per_Wt_{Compx} = Adj_Per_Inv_{Compx}/SUM(Adj_Per_Inv_{Comp1}:Adj_Per_Inv_{Compx})
Adj_Dist_Wt_{Compx} = Adj_Dist_Inv_{Compx}/SUM(Adj_Dist_Inv_{Comp1}:Adj_Dist_Inv_{Compx})
Adj_Age_Wt_{Compx} = Adj_Age_Inv_{Compx}/SUM(Adj_Age_Inv_{Comp1}:Adj_Age_Inv_{Compx})

The Weight of Comparablex is calculated to be the following:

[Adj_{—}Ct_{—}Wt]+[Adj_{—}Per_{—}Wt]+[Adj_{—}Dist_{—}Wt]+[Adj_Age_{—}Wt]

Once each comparable property's weight has been determined, the system next calculates the Valuation for the Subject Property using the following formula.

Price_{Subject}=(Adj_Price_{Comp1}*Weight_{Comp1})+(Adj_Price_{Comp2}*Weight_{Comp2}). . . +(Adj_Price_{CompN}*Weight_{CompN})

The Standard Deviation is calculated as follows:

X=Adj_Price_{Comp}(1−N)

μ=Mean (Average) of the population of Adjusted Comparable Sales Prices

N=Number of Comparables

Variance=_{(1-N)}Σ(X−μ)²/N

(Average of squared deviation from the mean of each Adjusted Sales Price)

Standard Deviation=Square Root(Variance)

(Square Root of the Variance)

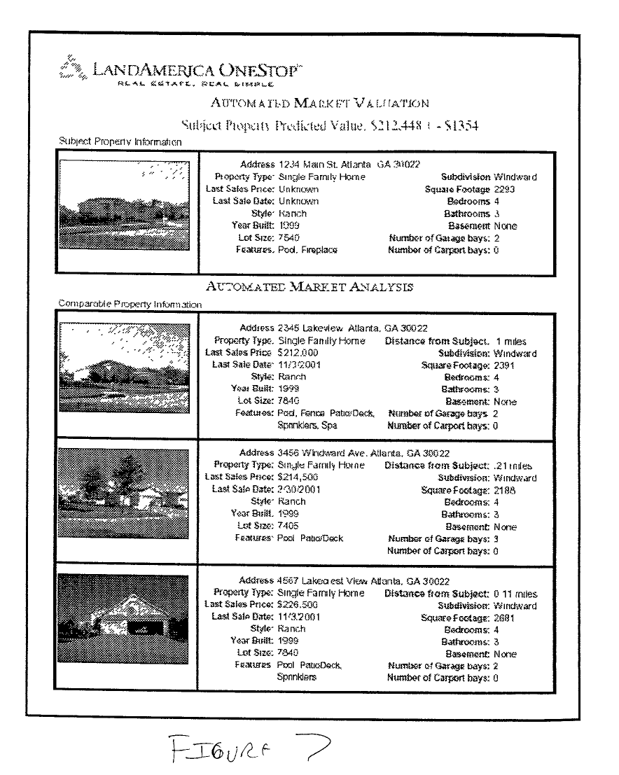

Once the valuation for the subject property and the related standard deviation for the comparables has been determined, the CALCULATE VALUATION step is completed. The next step in the overall process is the OUTPUT RESULTS step. During this step, the system outputs the valuation information for display to the user. The standard deviation information may also be displayed for the user in order to provide statistical information regarding the valuation range and the possible variation with respect to the valuation figure which was determined by the system. FIG. 7 is an example of one possible output screen which may be presented to the user in relaying valuation and comparable information to him or her.

Another aspect of the present invention which has been referred to herein is the fact that the system of the present invention, using either local or remote databases, can store various classes of information derived during the valuation process for use in later valuations or other processes. For example, as the system generates valuations, it is preferable that these valuations and data used in connection with these valuations be stored for later use if desired. Actual valuation numbers may be stored and may be employed as comparables for later valuations as appropriate as long as property information is either stored directly in the knowledge base database or can later be retrieved from other databases such as MLS and/or public record databases.

It is also possible for the system of the present invention to store and later use data respecting adjustments made to comparables in connection with valuation activity. This data may be used for reporting purposes and/or in connection with a determination in a later valuation whether the amount or level of adjustment is out of line with previous historical data on typical adjustment percentages. For example, if the average adjustment percentage based upon past system valuations is in the range of 3- 4% of sales price, the system may reject a comparable in a later valuation if it requires a 7% adjustment even though that adjustment is nevertheless within, for example, Fannie Mae guidelines. The system may also track trends in property valuations either generally or by particular geographic regions or by particular property characteristics. Again, this data may be used for reporting purposes and/or in connection with later valuations which are processed by the system.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

What is claimed is:

1. A method for determining a valuation for a subject real property comprising the steps of:
receiving information descriptive of the subject real property;
accessing additional information descriptive of the subject property from at least one subject property database and populating a subject property record based thereupon;
identifying at least one comparable property based upon similarity of data in at least one field of the subject property record with data in a corresponding field in a comparable property record associated with said at least one comparable property;
calculating a valuation for said subject real property based upon a value assigned to said at least one identified comparable property.

2. The method of claim 1 further including the step of determining whether a minimum amount of additional information descriptive of the subject property is available through said at least one database prior to initiating the step of identifying at least one comparable property.

3. The method of claim 2 wherein, if the said minimum amount of additional information descriptive of the subject property is not available, then processing terminates.

4. The method of claim 1 wherein the process is carried out by a server computer accessible by a client computer through the internet.

5. The method of claim 1 wherein said comparable property record is populated through access to at least one comparable property database.

6. The method of claim 5 wherein said at least one subject property database comprises at least one MTLS database.

7. The method of claim 5 wherein said at least one comparable property database comprises at least one MLS database.

8. The method of claim 5 wherein said at least one comparable property database comprises at least one MLS database and said at least one subject property database comprises at least one MLS database.

9. The method of claim 5 wherein said at least one comparable property database comprises a public record database.

10. The method of claim 5 wherein said at least one subject property database comprises a public record database.

11. The method of claim 5 wherein said at least one subject property database comprises at least one MLS database and at least one public record database and said at least one comparable property database comprises at least one MLS database and at least one public record database.

12. The method of claim 1 wherein a user is prompted for and must enter a street address and a zip code, or alternatively, a street address, a city and a state prior to initiation of the receiving of information descriptive of the subject property step.

13. The method of claim 1 wherein the step of identifying at least one comparable property further comprises the steps of:
for each potential comparable property, determining if the potential comparable property meets a minimum similarity test with respect to a least one predetermined field;
if said potential comparable property does meet said minimum similarity test with respect to said at least one predetermined field, including said potential comparable in a pool of potential comparables to be ranked; and
ranking said potential comparable properties in said pool of potential comparables to be ranked.

14. The method of claim 13 wherein said step of ranking said comparable properties further includes the steps of
determining a ranking for each of a plurality of fields for each said potential comparable properties;
according a weight to each of said fields;
ranking said potential comparable properties against one another based upon said weight accorded to each of said fields and the rankings determined for each of said plurality of fields with respect to each said potential comparable property.

15. The method of claim 1 further comprising the step of performing adjustments to an initial comparable valuation based upon data contained within at least one of the fields of said comparable property record as said data compares to the associated data within the said subject property record.

16. The method of claim 15 wherein said step of calculating a valuation for said subject property further comprises determining a net adjustment for each of said comparables, calculating an adjusted sales price for each comparable property, weighting each of said comparables and then calculating a final valuation for said subject property based thereupon.

17. The method claim 1 where final valuation data is retained in a knowledge base and is used in connection with later valuations.

18. The method of claim 17 wherein intermediate calculations are retained in a knowledge base and are used in connection with later valuations.

19. A real property valuation system comprising;
a subject property information prompting component for receiving information descriptive of the subject real property;
a subject property look up component for accessing additional information descriptive of the subject property from at least one subject property database and populating a subject property record based thereupon;
a comparable identification component for identifying at least one comparable property based upon similarity of data in at least one field of the subject property record with data in a corresponding field in a comparable property record associated with said at least one comparable property; and
a valuation calculation component for calculating a valuation for said subject real property based upon a value assigned to said at least one identified comparable property.

20. The real property valuation system of claim 19 wherein each of said components comprise a software process running on a server computer and accessible by a client computer.
